(19) United States
(12) Patent Application Publication
(10) Pub. No.: US 2013/0131847 A1
(43) Pub. Date: May 23, 2013

(54) DEVICE, METHOD AND PROGRAM FOR ORGANIZING A CELEBRITY SPORTING EVENT

(71) Applicant: Christian ROCHET, Gingins (CH)

(72) Inventor: Christian ROCHET, Gingins (CH)

(21) Appl. No.: 13/741,199

(22) Filed: Jan. 14, 2013

Related U.S. Application Data
(63) Continuation of application No. 12/385,355, filed on Apr. 6, 2009, now abandoned.
(60) Provisional application No. 61/064,961, filed on Apr. 4, 2008.

(51) Int. Cl. G06F 17/00

(52) U.S. Cl. CPC G06F 17/00
USPC 700/91

(57) ABSTRACT

Event organization devices, methods, and programs for organizing a competitive event including at least one sponsor, a plurality of participants and at least one celebrity are provided. The devices, methods, and programs plan the sale of a right to play in a competitive event to the participants and match the participants with the celebrity for only a portion of the competitive event such that each of the participants plays in the competitive event alongside the celebrity during the portion of the competitive event. The devices, methods, and programs calculates revenue to be distributed from the competitive event to at least one of one or more of the participants, the sponsor, and the celebrity.

This is a Continuation of application Ser. No. 12/385,355 filed Apr. 6, 2009, which in turn is a non-provisional application of U.S. Provisional Patent Application No. 61/064,961 filed Apr. 4, 2008. The disclosure of the prior applications is hereby incorporated by reference herein in its entirety.

### BACKGROUND

Related technical fields include sporting event planning devices, methods and programs.

### SUMMARY

A celebrity sporting event is a powerful mechanism for raising money. The participation of a celebrity draws a larger crowd than would normally participate or spectate. The anticipation of participating in the sporting event with a celebrity can also increase the entry fee that participants are willing to pay. The increased participation and increased entry fees enable the sporting event to raise more money commercially or for charity.

However, when such a sporting event is centered around one celebrity, it may become difficult for the celebrity to interact with each of the paying participants. If paying participants have less expectation of interacting with the celebrity, they may be less willing to participate or less willing to pay high entry fees.

Embodiments of the broad principles described herein provide devices, methods, and computer-implementable programs for organizing a celebrity sporting event centered around one celebrity, or a small number of celebrities, in which each participant can expect to interact with the celebrity(ies) during the course of the sporting event.

Embodiments provide an event organization device for organizing a competitive event including at least one sponsor, a plurality of participants and at least one celebrity. The device may include a controller, a memory and an input/output interface operatively coupled via a bus. The controller plans the sale of a right to play in a competitive event to the participants and matches the participants with the celebrity for only a portion of the competitive event such that each of the participants plays in the competitive event alongside the celebrity during the portion of the competitive event. The controller calculates revenue to be distributed from the competitive event to at least one of one or more of the participants, the sponsor, and the celebrity.

Embodiments provide a computer-readable recording medium storing a computer-executable program for organizing a competitive event including at least one sponsor, at least one participant and at least one celebrity. The program may include instructions that cause a computer to plan the sale of a right to play in a competitive event to the participants and match the participants with the celebrity for only a portion of the competitive event such that each of the participants plays in the competitive event alongside the celebrity during the portion of the competitive event. The program may include instructions that cause a computer to calculate revenue to be distributed from the competitive event to at least one of one or more of the participants, the sponsor, and the celebrity.

Embodiments provide an event organization method for organizing a competitive event including at least one sponsor, a plurality of participants and at least one celebrity, the method including selling a right to play in the competitive event to the participants and matching each participant with the celebrity for only a portion of the competitive event such that each participant plays in the competitive event alongside the celebrity during the portion of the competitive event. The method includes distributing revenue from the competitive event to at least one of: one or more of the participants, the sponsor, and the celebrity. The method may be controller implemented.

### BRIEF DESCRIPTION OF THE DRAWINGS

Exemplary embodiments are described in detail below with reference to the accompanying drawings wherein like numerals reference like elements, and wherein:

FIG. 1 is a flowchart illustrating an exemplary sporting event organization method;

FIG. 2 is a block diagram of an exemplary celebrity sporting event organization device;

FIG. 3 is a flowchart illustrating an exemplary subroutine process for initial organization of the sporting event;

FIG. 4 is a flowchart illustrating an exemplary subroutine process for celebrity-team matching; and

FIG. 5 is a flowchart illustrating an exemplary subroutine process for revenue allocation.

### DETAILED DESCRIPTION OF EMBODIMENTS

The following provides a description of examples of the broad principles described herein and as illustrated in the accompanying figures. The following examples are described in the context of a sports tournament including one or more celebrities. However, it should be appreciated that the broad principles described herein apply to other types of gaming activities and events without departing from the spirit and scope of the disclosure.

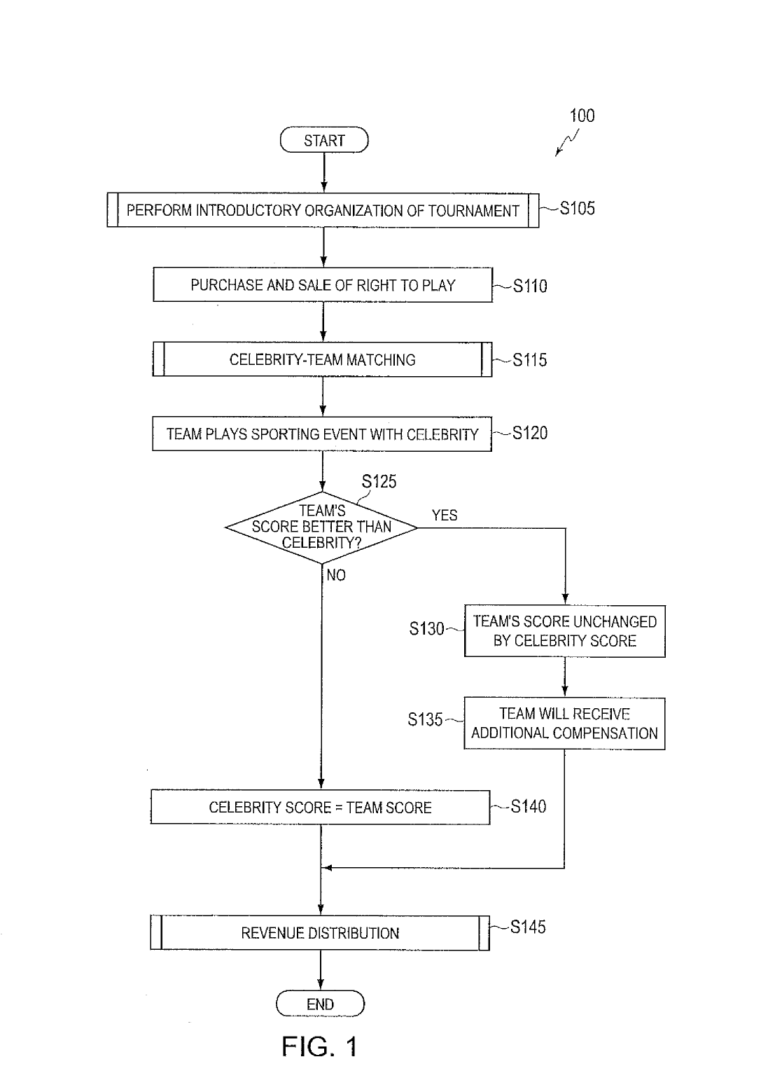

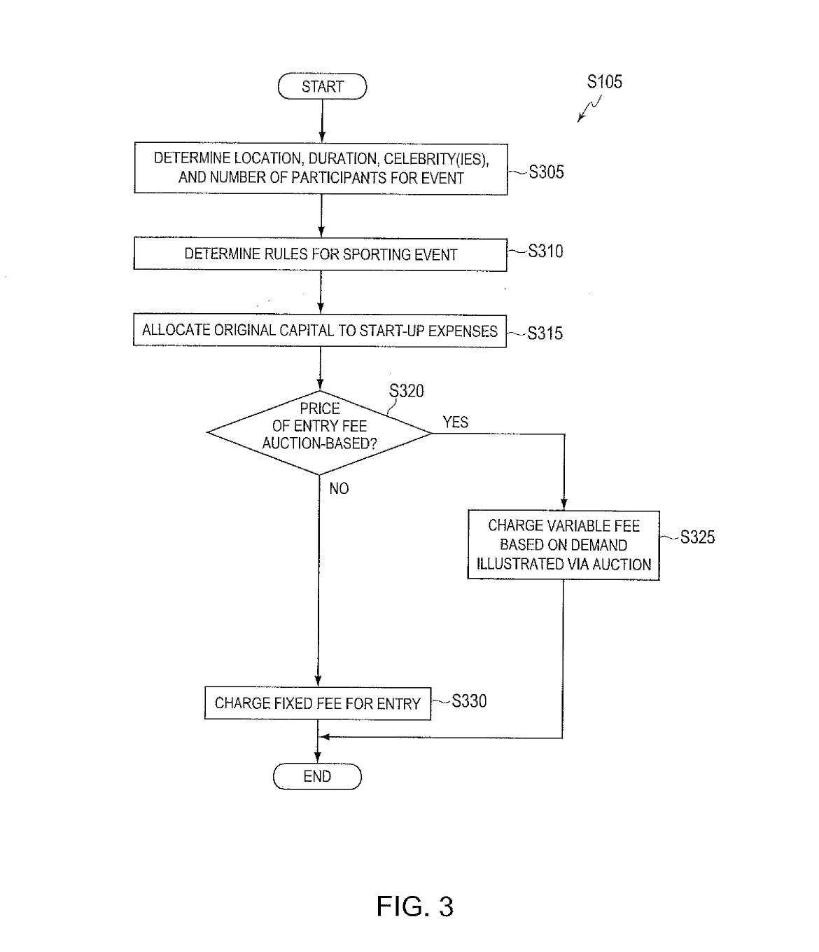

FIG. 1 illustrates an exemplary sporting event organization process 100. As shown in FIG. 1, the process begins and proceeds to the basic and introductory organization of the celebrity sporting event at S105. As will be described below in more detail with reference to FIG. 3, various rules and regulations can be established in S105, before the sporting event begins, to facilitate the initial sporting event organization. The method of organizing the sporting event may include one or more steps of: selecting a celebrity, selecting a location, determining a number of playing participants, determining a ticket price, and/or determining which portion of the sporting event each participant will play with the celebrity.

By way of example, assume the sporting event is a golf tournament. In this case, S105 would further include a step of determining a number of holes to be played, which may be selected based on the number of participants. Alternatively, the number of participants may be based on the number of holes. Once initial organization of the tournament has been conducted, the process proceeds to S110.

In S110, participating teams or individuals purchase the right to play in the sporting event alongside their favorite celebrity. The right to play may be purchased at auction Internet web sites such as EBay®, or the sporting event's custom webpage, for example. Alternatively, or in addition to the above, the sporting event may use call centers to facilitate telephone purchases of the right to play in the event. Customers may also pay in person at the event location on the scheduled day of the event, if tickets are still available at that time. Of course, any method of payment may be used to purchase a right to play including, but not limited to, credit cards, debit cards, cash, personal checks, cashier's checks, traveler's checks, foreign currency, canned goods, stock, property interests or any other form of legitimate consideration. Once a participant has purchased a right to play, the process proceeds to S115.

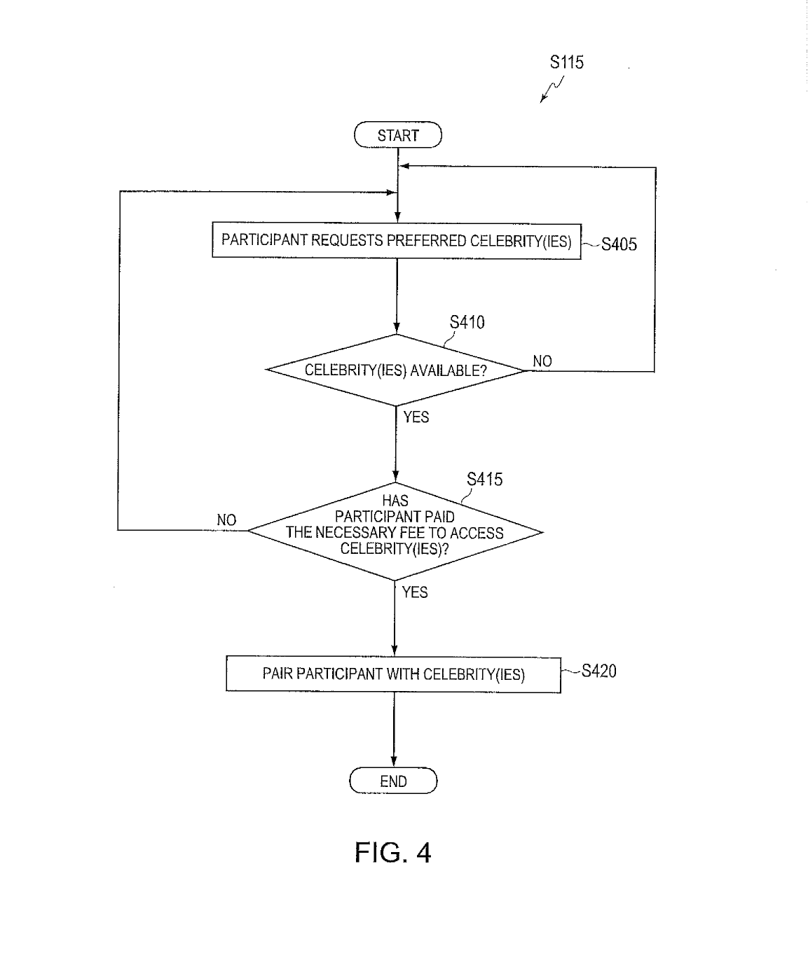

S115 matches the participants and celebrity(ies) according to predetermined rules and regulations, an example of which will be discussed below in more detail with reference to FIG. 4. Once the participants are matched with the corresponding celebrity(ies), the process proceeds to S120.

In S120, a team or individual participant(s) will participate in the sporting event at least partially alongside the celebrity. The sporting event may include various rules and regulations designed to allocate the celebrity's time with each participant of the sporting event. For example, a celebrity golf tournament may be organized so that a single celebrity plays with the paying participants or plural celebrities play. A celebrity's playing time may be distributed among several different teams or individuals so that each participant can play with the celebrity, even if only for a short time. The celebrity may be, for example, a professional golfer, a movie star, or a political figure. The tournament may be arranged so that the number of holes played is equal to, or a multiple of, the number of participants or teams. Thus, for example, if there are 36 paying participants, the tournament may be a two-day tournament in which 18 holes are played on each day (i.e., 2 days×18 holes=36 holes).

According to this example, each paying participant would purchase a ticket for the entire two days. Therefore, each participant would play all 36 holes. By playing all 36 holes, each participant would be guaranteed to play at least one hole with the celebrity. For the remaining holes, the participants would play on their own or in groups of, for example, four.

When each participant plays a hole with the celebrity, that hole may be played in, for example, a “best ball” format. According to “best ball” format, for the duration of the hole, the participant who is playing with the celebrity is permitted to play their next shot from either the location of their own ball or the location of the celebrity's ball. This format not only allows the participant who is playing with the celebrity the satisfaction of choosing a possibly superior ball location for their next shot, but also permits increased interaction with the celebrity because the participant will be playing from the same location as the celebrity, thereby allowing more direct contact with the celebrity including, for example, coaching by the celebrity.

S125-S140 illustrate an optional component of the sporting event organization process in which the participating teams or individuals compete against, yet play on the same team as, the participating celebrity. Considering again the golf tournament example, assume a celebrity (e.g., Tiger Woods) rotates his or her playing time between 36 different teams for 36 different holes of golf, as described above. During each hole of golf, the team's best individual score would be reported to the scorekeepers, regardless of whether the best score was the celebrity's score.

Presumably, the celebrity in this example would achieve the highest score given his expertise in playing golf, and thus the celebrity's score would be the reported score for the team, as shown in S140. If, however, any individual of the team happens to achieve a better score than the celebrity, the individual's score would be reported to the scorekeepers, as shown in S130, and the team would receive a cash prize or other award for achieving a score better than the celebrity, as shown in S135. Alternatively, or in addition to the above, the team could compete against the celebrity as a collective unit using the “best ball” process described above to possibly achieve a score superior to that of the celebrity. Once the above optional component is completed, the process proceeds to S145.

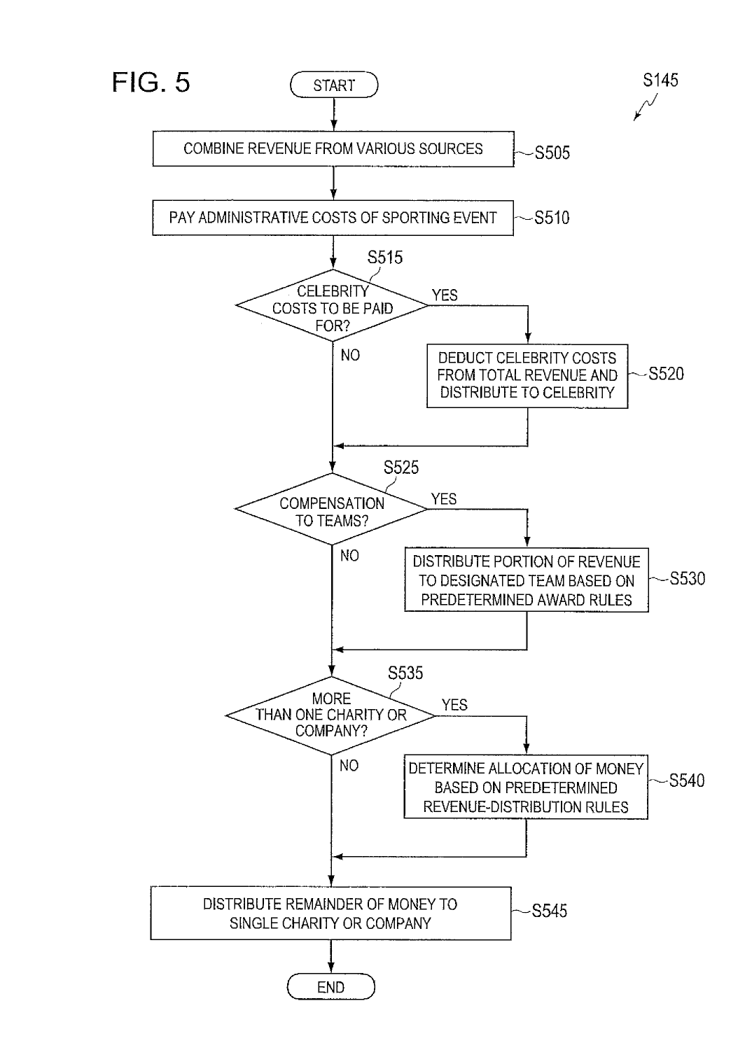

In S145, the revenue collected by the sports tournament to various parties is distributed based on predetermined priority distribution rules, for example, described below in more detail with reference to FIG. 5. For example, the golf tournament may be set up in such a manner that all of the celebrity's expenses, and optionally any fees, are paid for by the organizer. Furthermore, to increase participation, a percentage of the money raised may be redistributed to paying participants in the form of monetary, physical, or other prizes, for example, for having the lowest total score, for scoring a hole-in-one, for having the longest drive, or for getting their ball closest to the pin on a particular par-three hole. The remaining profit from the tournament may be donated to a specified sponsor, such as one or more charities. After all revenue has been distributed according to the predetermined rules and regulations, the process ends.

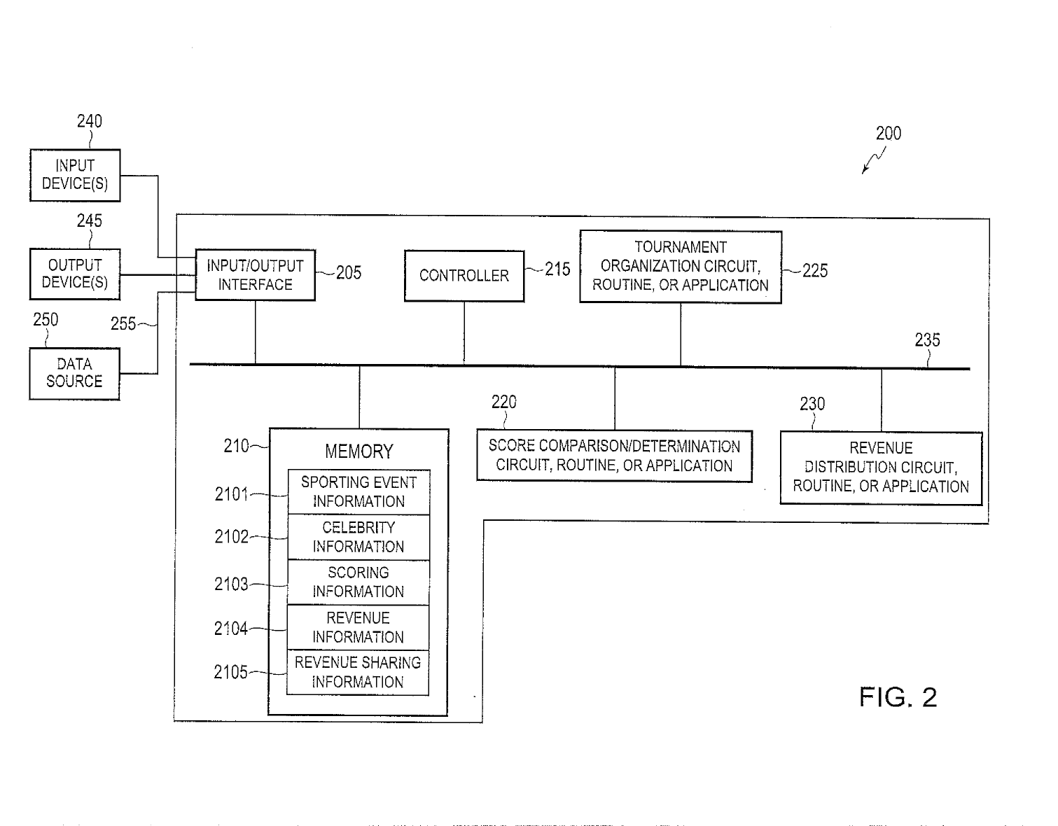

It should be appreciated that all or part of the above-described process 100 may be device implemented. For example, all or part of the algorithm described above and shown in the flowcharts of FIG. 1, FIG. 3, FIG. 4 and/or FIG. 5 may be implemented as computer-executable program instructions hardwired into the device or as program instructions stored on a computer-readable medium within or attached to the device. An example of such a device 200 is shown in FIG. 2 and described below; however, devices capable of implementing the process 100 need not be limited to the device 200.

FIG. 2 is a block diagram of an exemplary organizational device 200. As illustrated in FIG. 2, the organizational device 200 may physically, functionally, and/or conceptually include an input/output interface 205, a memory 210, a controller 215, a score comparison/determination circuit, routine, or application 220, a tournament organization circuit, routine or application 225 and a revenue distribution circuit, routine or application 230. As shown, the above components can be coupled together through a control/signal bus 235. Additionally, the input/output interface 205 may be operatively coupled to one or more input device(s) 240, output device(s) 245, and/or data source(s) 250 by way of communication links 255.

The input/output interface 205 may be any device that transmits and/or receives data and that is capable of inputting or outputting data. For example, the input/output interface 205 can send and receive transmissions to or from the input device(s) 240, the output device(s) 245, and the data source(s) 250 via the communication links 255. The input/output interface 205 may facilitate the purchase and sale of the right to play in the sporting event and may store such information in the memory 210 internal to the organizational device 200, or in the data source 250 external to the organizational device 200, as shown in FIG. 2.

The memory 210 can include one or more portions for storing data relating to the sporting event. For example, as shown in FIG. 2, the memory 210 can include a portion for storing information relating to the general organization of the sporting event 2101, information relating to the celebrity(ies) participating in the sporting event 2102, the scores of the various teams, individuals and/or celebrity(ies) participating in the sporting event 2103, revenue information including the total revenue, sources of revenue and expenditures of the sporting event 2104, and revenue sharing information 2105 for determining the recipient of leftover revenue once the sporting event has been completed.

The memory 210 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or re-writeable optical disk and disk drive, a hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

The controller 215 can be, for example, a computer processor embodied within a personal computer, or any other device that allows for the control of transmission and reception of data via a network. In the embodiment shown in FIG. 2, the input/output interface 205, the memory 210, the score comparison/determination circuit, routine, or application 220, the tournament organization circuit, routine or application 225 and the revenue distribution circuit, routine or application 230 all operate under the control of the controller 215. Furthermore, one or more of the score comparison/determination circuit, routine, or application 220, the tournament organization circuit, routine or application 225, and the revenue distribution circuit, routine or application 230 may be implemented by the controller-executable program instructions.

The score comparison/determination circuit, routine, or application 220 can be any physical circuit, controller, program, or algorithm that compares the scores of the sporting event and determines the best score. The score comparison/determination circuit, routine, or application 220 can be operated and implemented by the controller 215, and may store relevant information in the memory 210 or the data source 250, to determine various relationships between scores of the parties participating in the sporting event.

The tournament organization circuit, routine or application 225 can be any physical circuit, controller, program, or algorithm that organizes general attributes and policies of the sporting event. Like the score comparison/determination circuit, routine, or application 220, the tournament organization circuit, routine or application 225 can be operated and implemented by the controller 215.

The revenue distribution circuit, routine or application 230 may be any physical circuit, controller, program, or algorithm that facilitates the distribution of revenue to deserving parties. The revenue distribution circuit, routine or application 230 may communicate with the tournament organization circuit, routine or application 225 and memory 210 to determine which parties should receive revenue, and in what amount, based on the predetermined rules and regulations associated with the sporting event. The revenue distribution circuit, routine or application 230 may cause revenue to be transmitted directly into an external bank account of the deserving parties, or may cause a check addressed to the deserving parties to be printed. The revenue distribution circuit, routine or application 230 may also be operated and controlled by the controller 215.

The input device(s) 240 and output device(s) 245 can be a device of any type that allows for the transmission and/or reception of data. The data can include requests to purchase a right to play in the sporting event or personal information of the participating individuals or teams that can be transmitted to the memory 210 of the organizational device 200. By way of example, the input device(s) 240 and output device(s) 245 can be any device, such as voice and video telephone sets, streaming audio and video media players, integrated intelligent digital television receivers, DBS receivers, personal computers, work stations, servers, radios, personal digital assistants, PCS/cellular wireless voice and Internet phones, mobile satellite receivers, GPS receivers, or any combinations of these.

The data source 250 can be a locally or remotely located laptop or personal computer, a personal digital assistant, a tablet computer, a device that stores and/or transmits electronic data, such as a client or a server of a wired or wireless network, such as for example, an intranet, an extranet, a local area network, a wide area network, a storage area network, the Internet (especially the World Wide Web), and the like. In general, the data source 250 can be any known or later-developed source that is capable of providing any form of data to the organizational device 200 through the input/output interface 205.

The communication links 255 may be any type of connection, wired or wireless, that allows for the transmission of information. Some examples include conventional telephone lines, digital transmission facilities, fiber optic lines, direct serial/parallel connections, cellular telephone connections, satellite communication links, local area networks (LANs), Intranets and the like.

During operation of the organizational device 200, the controller 215 may organize general attributes and details of the sporting event by executing or controlling the tournament organization circuit, routine or application 225. For example, under control of the controller 215, the tournament organization circuit, routine or application 225 may determine a location of the sporting event, a duration of the sporting event, and the celebrities and participants of the sporting event. Once the above attributes are determined, the tournament organization circuit, routine or application 225 may establish various rules for the sporting event so that each participant can play alongside at least one celebrity for at least a portion of the event. Again referring to the golf tournament example, the controller 215 may cause the tournament organization circuit, routine or application 225 to determine the number of holes that the participants will be able to play alongside the celebrity(ies) based on the number of participants and celebrity(ies).

As can be appreciated, depending on the number of playing participants and celebrity(ies), it can become complicated to arrange a format, for example, in which each paying participant can play at least one hole with the participating celebrity. This is especially the case in other sports such as, singles/doubles sports, team sports, etc. Thus, in this advantageous embodiment, the format of the tournament (e.g., the total number of holes, the number of holes played per day, number of paying participants, the particular hole and time at which each paying participant will play with the celebrity, etc.) may be determined with the aid of the tournament organization circuit, routine or application 225, as controlled by the controller 215. For example, the tournament organization circuit, routine or application 225 may mathematically compute the largest portion of celebrity-side playing time for each participant based on the number of participants and celebrity(ies), the duration of the golf tournament, economic restrictions, and any other factor that may limit or expand the amount of playing time for the tournament.

A participant may purchase or sell the right to play in the sporting event and the controller 215 may store such information in the memory 210 internal to the organizational device 200, or in the data source 250 external to the organizational device 200, as shown in FIG. 2. The right to play may be purchased on Internet web sites such as EBay® or the sporting event's custom webpage, for example. Participants of the sporting event may transmit orders from the input device(s) 240 or output device(s) 245, by transmitting the orders via the communication links 255 and the input/output interface 205. Once these orders are received, the controller 215 may cause the order information to be stored in the sporting event information area 2101 and revenue information area 2104 of the memory 210 so that users of the organizational device 200 can easily access such information as required in the future.

The right to play in the sporting event may be priced as a fixed fee, may be auctioned to the highest bidder, or may vary with demand for the sporting event date as the event date approaches. Furthermore, the ticket price may be based on the number of holes or vice-versa. The price of the right to play may also depend on the celebrity who the participant will play alongside. For example, when multiple celebrities participate, participants who pay a higher entry fee may play with a more prestigious celebrity as compared to participants who pay a lower entry fee. Furthermore, participants who pay a higher entry fee may play with more than one of the participating celebrities while participants who pay a lower entry fee may play with only one celebrity. In this manner, while at least one celebrity will play alongside each participant of the sporting event, higher paying customers may obtain increased interaction with the celebrity(ies). Thus, the use of the tournament organization circuit, routine or application 225, as controlled by the controller 215, can be even more advantageous when multiple celebrities participate in the sporting event.

The conduction of the sporting event itself may also be assisted by the organizational device 200. For example, by using the rules and regulations of the sporting event established by the tournament organization circuit, routine or application 225 and stored in the memory 210 by the controller 215, a user of the organizational device 200 may access and communicate the rules of the sporting event to the participants and celebrities. Further, by using the score comparison/determination circuit, routine, or application 220, the user of the organizational device 200 may compare the scores of celebrities and/or participants and determine a winner for a specific portion of the sporting event or for the sporting event as a whole.

By way of example, consider the sporting event is a golf tournament and the celebrity is a professional golf player. During each hole of the golf tournament, the score comparison/determination circuit, routine, or application 220 may determine the score of the team or of the team's best individual, and may compare that score against the celebrity's score. If the celebrity's score is better than the team score or any individual score on the team (which would be expected), the celebrity's score would be stored, in the scoring information portion 2103 of the memory 210, as the team's score for that individual hole of the golf tournament. If, however, any individual of the team happens to score better than the celebrity, the individual's score could be stored in the scoring information portion 2103 of the memory 210 as the team's score, and the team could receive a cash prize or other award for achieving a better score than the golf professional.

Either before, during, or after the sporting event, the revenue distribution circuit, routine or application 230 can distribute the excess revenue of the sporting event to deserving participants, companies, charities, and/or celebrities, as the rules and regulations of the sporting event permit. For example, the controller 215 may cause the revenue distribution circuit, routine or application 230 to distribute revenue to the celebrity, (e.g. to pay for his/her costs associated with attending the sporting event), and/or may distribute cash prizes to individual or team participants based on the performance of the participants in the sporting event. Such prizes could include monetary, physical, or other prizes, for achieving the lowest total score, for scoring a hole-in-one, for having the longest drive, or for getting his or her ball closest to the pin on a particular par-three hole. Of course, participants could earn any prize for any achievement in connection with the sporting event without departing from the spirit and scope of the present disclosure.

Optionally, the sporting event could be sponsored by several companies or charities and the controller 215 could cause the revenue distribution circuit, routine or application 230 to distribute excess revenue to the several companies and charities in connection with the rules and regulations of the sporting event. For example, if the sporting event were sponsored by the Tiger Woods Foundation® and the Dream Vaccines Foundation®, the revenue could be split between the two charities equally, i.e., 50-50. However, the revenue distribution circuit, routine or application 230 could further analyze the revenue to determine which charity contributed most to the sporting event revenue, and may distribute the revenue accordingly. To determine the source of the revenue, participants can be polled to determine their purpose for participating in the tournament. Accordingly, the source of the income can be estimated and allocated to the various charities based on the results of the participant poll.

Revenue sources need not be limited to entry fees alone. For example, cash or property donations may also be included in the total revenue stream for the sporting event. Furthermore, the tournament may be broadcast on television. Thereby, in addition to entry fees, the tournament may generate television-advertising revenue that will contribute to the distributed profits. Also, the sporting event could hold a formal “black tie” dinner and could charge an entry fee for the dinner (either included with or in addition to the entry fee for the golf tournament) to raise additional revenue for the companies or charities involved.

All of the above fee collections, management and distributions may be controlled by the revenue distribution circuit, routine or application 230 under control of the controller 215.

FIG. 3 is a flowchart illustrating an exemplary subroutine process for conducting initial organization of the sporting event, for example, as in S105. The process starts and proceeds to S305, where a location of the sporting event, a duration of the sporting event, the celebrities participating in the sporting event, and a number of participants for the event are determined. The determined location can be a general location (for example, Augusta, Ga.), or a specific golf course (for example, Augusta National Golf Club). Further, the duration of the sporting event can be a fixed time limit (for example, four hours) or can be a specified number of holes (for a golf tournament), innings (for a baseball tournament), sets (for a tennis tournament), or the like. The number of participants and the number of celebrities for the event may be determined based on the consumer demand for the sporting event, and/or based on the sponsoring charities or companies involved in the sporting event. Once the above preliminary matters have been determined, the process proceeds to S310.

In S310, the general rules for the sporting event are determined. Again using the golf tournament example, the tournament may be organized so that the celebrity plays at least one hole with each of the participants. For example, the celebrity may commit to playing 36 holes, and 36 individual participants (or teams of participants) may be correspondingly matched with the celebrity so that each participant can play alongside the celebrity for at least one hole. Further changes to the rules and regulations of the sporting event may be conducted, for example, providing a “handicap” to the participants so that their scores may compare more favorably to the celebrity, or allowing the teams of participants to play a “best ball” format of golf, while requiring the celebrity to play a more traditional format of golf. After the initial rules for the sporting event are determined, the process proceeds to S315.

The initial expenses for the sporting event can be allocated on paid from the original capital contributions for the sporting event, as shown in S315. For example, expenses for renting the location of the sporting event, for paying the celebrities travel expenses, equipment rental, referee/umpire fees, or other such logistical fees may be paid from the original capital contributions. Alternatively, revenue may simply be set aside for the above expenses, without actually paying the expenses until after the sporting event has concluded. Once start-up expenses have been accounted for, the process proceeds to S320.

Steps S320-S330 generally determine the price to be charged to participants of the sporting event. For example, prices may be determined in an auction format (as shown in S320) or the price of the sporting event may simply be a fixed fee that is charged throughout the purchase and sale process (as shown in S330). Optionally, the entry fee for the sporting event may change based on consumer demand, similar to the price of a share of stock, or an airline ticket. Once the price of the entry fee is determined in accordance with S320-S330, the process according to FIG. 3 ends.

FIG. 4 is a flowchart illustrating an exemplary subroutine process for matching participants and celebrities, for example, the process of S115. The process begins and proceeds to S405, where the participant selects a preferred celebrity. Of course, if only one celebrity is participating in the sporting event, this step may be excluded.

It should be appreciated that a celebrity may not be available for a variety of reasons, even if requested by the participant of the sporting event. For example, celebrities may be available only on a first come/first served basis, and thus a popular celebrity (for example, Tiger Woods) may no longer be available to a participant of the sporting event if the participant requests the celebrity during the late stages of event planning. As shown in FIG. 4, when a user requests a preferred celebrity in S405 but the celebrity is unavailable in S410, the process reverts back and prompts the user again for their preferred celebrity in S405.

Further, participants of the sporting event may pay increased fees and can obtain preferential celebrity pairing based on the additional revenue contributed to the sporting event. For example, in S415, the system determines whether or not the participant has paid the necessary fee to access the celebrity requested by the participant. It should be appreciated that other forms of preferential treatment may be granted to the participant based on increased fees paid to the sporting event. For example, the participant may be granted access not only to their favorite celebrity, but also may be granted access for a larger duration of the sporting event, or may be granted access to more than one celebrity, based on the additional fees paid to the sporting event. If the participant has not paid the necessary fees to access a particular celebrity, the process reverts back to S405 and the participant is notified that the requested celebrity is unavailable at that fee, and is prompted to request a different celebrity or pay an increased fee. However, if the celebrity is available and the participant has paid the necessary fees to access the celebrity, the participant is paired with the celebrity in S420 for a particular portion of the sporting event, and the process according to FIG. 4 ends.

FIG. 5 is a flowchart illustrating an exemplary subroutine process for allocating revenue for the sporting event, e.g., according to S145. The process starts and proceeds to S505, where revenue from various sources can be combined and accounted for prior to such revenue being distributed. Such a combination of revenue may be helpful if the sporting event acquires revenue through multiple sources. For example, the sporting event may acquire revenue by private donations, entry fees, merchandizing, and/or formal dinner events (for example, “black tie” dinners), and it may be difficult to account for the total revenue of the sporting event without combining and accounting for each of these sources. Once a total revenue from the various sources has been determined, the process proceeds to S510.

In S510, the administrative costs of the sporting event are granted priority and are paid before other revenue is distributed to various parties of the sporting event. Administrative costs can include, for example, rental fees for the sporting event venue, rental fees for equipment, event staff wages, and the like. While FIG. 5 illustrates the administrative fees as having priority over all other revenue distribution allocations, other priority schemes may be employed without departing without the spirit of the disclosure. Once administrative costs have been paid, the process proceeds to S515.

In S515, the system determines whether or not the celebrity costs (for example, celebrity travel expenses, lodging expenses, food expenses, and attendance fees), are to be paid for by the sporting event. If so, the process deducts the celebrity costs from the total revenue and distributes such costs to the celebrity in S520. If not, the process proceeds to S525.

In S525, the process determines whether or not various teams or individuals of participants are to be given compensation for participating in the sporting event, or whether any prizes should be awarded to the individual or teams based on their performance in the sporting event. If the individuals or teams are to be given such revenue, the system distributes a portion of the revenue to the designated team based on predetermined award rules in S530. If the individuals and teams are not to be compensated, the process proceeds to S535.

In S535, the process determines whether or not a plurality of charities or companies are involved in the planning and sponsorship of the sporting event. If a plurality of sponsors exist, the step may determine the allocation of money based on predetermined revenue distribution rules in S540. For example, revenue may be split equally between two sponsors, or revenue can be split based on which sponsor attracted the most revenue. Of course, if only one sponsor exists, the process proceeds to S545, wherein the remainder of the revenues is distributed to a single sponsor, and the process ends.

The exemplary method, device, and computer programs implementing the method may include additional steps as well, such as determining prize amounts, determining the celebrity's expenses, determining the celebrity's availability, etc.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, the organizational method described above may be applied to sports or activities other than golf, such as, for example, tennis, card games, and automobile racing. In each of theses other sports or activities, the format could be arranged such that, for example, the celebrity participates with and/or coaches each paying participant for one tennis game, for a certain number of card games, for a timed lap around a racing track, or the like.

What is claimed is:

1. An event organization device for organizing a competitive event including at least one sponsor, a plurality of participants and at least one celebrity, the device comprising:
a controller, a memory and an input/output interface operatively coupled via a bus, wherein the controller:
plans the sale of a right to play in a competitive event to the participants;
matches the participants with the celebrity for only a portion of the competitive event such that each of the participants plays in the competitive event alongside the celebrity during the portion of the competitive event; and
calculates revenue to be distributed from the competitive event to at least one of one or more of the participants, the sponsor, and the celebrity.

2. The device according to claim 1, wherein the competitive event is a golf tournament including a plurality of holes, and the portion of the competitive event is at least one hole of the golf tournament.

3. The device according to claim 2, wherein the controller reports a team score for each portion, the team score being a best score of the participants or a score of the celebrity.

4. The device according to claim 1, wherein the controller awards a participant a prize if that participant achieves a score better than a score of the celebrity during that participant's portion.

5. The device according to claim 1, wherein the controller:
determines a number of the participants and a number of the celebrities; and
computes a duration of each participant's portion based on the number of participants and the number of celebrities.

6. The device according to claim 1, wherein the controller assigns a participant increased access to the celebrity based on a higher price paid by the participant for the right to play.

7. A computer-readable recording medium storing a computer-executable program for organizing a competitive event including at least one sponsor, at least one participant and at least one celebrity, the program including instructions that cause a computer to:
plan the sale of a right to play in a competitive event to the participants;
match the participants with the celebrity for only a portion of the competitive event such that each of the participants plays in the competitive event alongside the celebrity during the portion of the competitive event; and
calculate revenue to be distributed from the competitive event to at least one of one or more of the participants, the sponsor, and the celebrity.

8. The recording medium according to claim 7, wherein the competitive event is a golf tournament including a plurality of holes, and the portion of the competitive event is at least one hole of the golf tournament.

9. The recording medium according to claim 8, further comprising instructions causing the computer to report a team score for each portion, the team score being a best score of the participants or a score of the celebrity.

10. The recording medium according to claim 7, further comprising instructions causing the computer to award a prize to a participant if that participant achieves a score better than a score of the celebrity during that participant's portion.

11. The recording medium according to claim 7, further comprising instructions causing the computer to:
determine a number of the participants and a number of the celebrities; and
compute a duration of each participant's portion based on the number of participants and the number of celebrities.

12. The recording medium according to claim 7, further comprising instructions causing the computer to assign a participant increased access to the celebrity based on a higher price paid by the participant for the right to play.

13. An event organization method for organizing a competitive event including at least one sponsor, a plurality of participants and at least one celebrity, the method comprising:
selling a right to play in the competitive event to the participants;
matching each participant with the celebrity for only a portion of the competitive event such that each participant plays in the competitive event alongside the celebrity during the portion of the competitive event; and
distributing revenue from the competitive event to at least one of: one or more of the participants, the sponsor, and the celebrity.

14. The method according to claim 13, wherein the competitive event is a golf tournament including a plurality of holes, and the portion of the competitive event is at least one hole of the golf tournament.

15. The method according to claim 14, further comprising reporting a team score, wherein for each portion, the team score is a best of a score the participants or a score of the celebrity.

16. The method according to claim 13, wherein a participant is awarded a prize if that participant achieves a score better than a score of the celebrity during that participant's portion.

17. The method according to claim 13, further comprising determining a number of the participants and a number of the celebrities and computing a duration of each participant's portion based on the number of participants and the number of celebrities.

18. The method according to claim 13, wherein a participant is provided with increased access to the celebrity based on a higher price paid by the participant for the right to play.

19. The method according to claim 13, wherein each step is implemented by a controller.
